(19) United States
(12) Patent Application Publication
(10) Pub. No.: US 2015/0198048 A1
(43) Pub. Date: Jul. 16, 2015

(54) METHOD FOR PRODUCING A STATOR BLADE AND STATOR BLADE

(71) Applicant: Siemens Aktiengesellschaft, Munich (DE)

(72) Inventor: Michael Handler, Erkrath (DE)

(73) Assignee: Siemens Aktiengesellschaft, Munich (DE)

(21) Appl. No.: 14/415,480

(22) PCT Filed: Jul. 15, 2013
(86) PCT No.: PCT/EP2013/064886

§ 371 Date: Jan. 16, 2015

(30) Foreign Application Priority Data
Jul. 25, 2012 (DE) 10 2012 213 017.9

(51) Int. Cl. F01D 5/18; B23P 15/04

(52) U.S. Cl. CPC F01D 5/187; B23P 15/04; F05D 2230/60; F05D 2220/30; F05D 2260/20; F05D 2230/13; F05D 2230/12; F05D 2250/232

(57) ABSTRACT

A method for producing a turbine vane with a vane airfoil and a vane root is provided to achieve a higher efficiency for a turbine. The method includes: a) production of a vane airfoil and a vane root as separate parts; b) introduction of a cooling air opening into the vane airfoil; and c) joining the vane airfoil and vane root together after step b).

### CROSS REFERENCE TO RELATED APPLICATIONS

This application is the US National Stage of International Application No. PCT/EP2013/064886 filed Jul. 15, 2013, and claims the benefit thereof. The International Application claims the benefit of German Application No. DE 102012213017.9 filed Jul. 25, 2012. All of the applications are incorporated by reference herein in their entirety.

### FIELD OF INVENTION

The invention relates to a method for producing a turbine blade having a blade airfoil and a blade root. It also relates to a turbine blade of this kind.

### BACKGROUND OF INVENTION

A turbine is a turbomachine which converts the internal energy (enthalpy) of a flowing fluid (liquid or gas) into rotational energy and ultimately into mechanical drive energy. A part of the internal energy of the fluid flow is extracted therefrom by the laminar flow, which is as swirl-free as possible, around the turbine blades, said part of the internal energy being transferred to the rotor blades of the turbine. Via the latter, the turbine shaft is then set into rotation, and the useful power is transmitted to a coupled working machine, for example to a generator. The rotor blades and the shaft are part of the movable rotor of the turbine, said rotor being arranged within a housing.

As a rule, a plurality of blades are mounted on the shaft. Rotor blades mounted in a plane each form a blade wheel or rotor wheel. The blades are profiled in a slightly curved manner, similarly to an airplane wing. Upstream of each rotor wheel there is usually a stator wheel. These stator blades project from the housing into the flowing medium and cause it to swirl. The swirl (kinetic energy) generated in the stator wheel is used in the subsequent rotor wheel in order to set the shaft, on which the rotor wheel blades are mounted, into rotation.

The stator wheel and rotor wheel together are designated a stage. Often, a plurality of such stages are connected in series. Since the stator wheel is stationary, the stator blades thereof can be fastened both to the inside of the housing and to the outside of the housing and thus provide a bearing for the shaft of the rotor wheel.

Both stator blades and rotor blades of the turbine usually comprise, in addition to the aerodynamically active actual blade airfoil, a blade root, which is also known as a platform, is widened compared with the blade airfoil and has fastening devices for fixing each particular blade for example to the rotor or to the housing. The blade root and blade airfoil are usually cast together in one piece during the production process and subsequently provided with a metal coating.

In order to cool the components, which are subjected to hot gas, of a turbine, in particular of a gas turbine, film cooling, inter alia, is used. This also applies for the turbine blades. In this case, the coolant—typically air—is guided through cylindrical or diffuser-like cooling-air openings onto the surface to be cooled in order to form a protective cooling film. The optimal cooling efficiency is obtained in that the cooling-air openings are inclined with respect to the surface, depending on the local flow conditions, along the flow lines.

During the production process, the cooling-air bores are introduced predominantly by laser or erosion methods. In the case of turbine stator blades, the accessibility for the laser or erosion tool is severely restricted in the region of the transition from the blade airfoil to the platform on account of the concave edge that occurs there. Three-dimensionally shaped blade airfoils having an angle between the pressure side of the blade airfoil and the platform of less than 90° and flow lines that are influenced by secondary flow effects make the introduction of optimally oriented cooling-air bores impossible.

Since the introduction of optimally oriented borers having a maximum cooling efficiency was not hitherto possible, the poorer cooling action had to be compensated by an increased number of non-optimal borers. As a result, the consumption of cooling air was increased and the aerodynamic efficiency of the row of blades reduced. Both result in impairment of the turbine efficiency.

Furthermore, EP 2 151 544 A2 discloses siting cooling-air openings close to the platform on the blade airfoil, in order to guide the cooling air flowing out therethrough onto the platform in order to allow film cooling there.

Moreover, EP 1 176 284 A2 discloses producing the turbine stator-blade segments in a modular manner in that a plurality of blade profiles are produced separately and are then welded to an outer ring and an inner ring.

### SUMMARY OF INVENTION

It is therefore an object of the invention to disclose a method for producing a turbine blade and a turbine blade with which greater efficiency of a turbine can be achieved.

With regard to the method, this object is achieved according to the invention in that the method comprises the following steps of: a) producing a blade airfoil and a blade root as separate components, b) introducing at least one cooling-air opening into the blade airfoil and/or into the blade root, or introducing at least two openings, at least one of which is arranged in the blade root and in the blade airfoil in each case, and c) assembling the blade airfoil and blade root after step b).

The invention is in this case based on the consideration that improving the efficiency of the turbine could be achieved in that the cooling-air bores could be introduced precisely in the region of the transition from the blade airfoil to the platform in an optimized manner with regard to the flow lines of the medium flowing around. However, this is only possible if the corresponding tools for introducing the openings have sufficient freedom of movement. This is achievable when the platform or blade root and blade airfoil are produced as separate parts and are assembled only when the openings have been introduced. Thus, the openings can be introduced through the blade root into the blade airfoil without impedance or the openings can be introduced through the blade airfoil into the blade root without impedance in each case in any desired flow-line optimized arrangement.

In an advantageous configuration, the production of the blade root and/or blade airfoil takes place by casting. As a result, production of the components in an exact form with little fault tolerance is ensured.

The introduction of the cooling-air openings advantageously takes place by laser and/or by means of electrical discharge machining. As a result, both the axis of the openings and the shape thereof can be controlled in a particularly easy manner.

In an advantageous configuration, the axis of the cooling-air opening is directed toward the blade root at the outer side of the blade airfoil or the axis of the cooling-air opening is directed toward the blade airfoil at the outer side of the blade root. Such openings are necessary precisely in the region of the concave edge between the blade airfoil and platform in order to ensure an optimal orientation of the cooling-air flow along the hot-gas flow lines. At the same time, they are particularly easy to produce with the described method since the blade root no longer impedes the introduction tool and the latter is freely movable.

In a further advantageous configuration, the method comprises the additional step of: d) coating a region of the blade root and blade airfoil with a coating.

As a result, following the assembly of the blade root and blade airfoil, a continuous coating which increases the thermal and/or mechanical resilience of the component can be applied.

In this case, it can be problematic that, in the described method, the coating only takes place once the cooling-air openings have been introduced. This can result in local clogging of the cooling-air openings. If the axis of the cooling-air bores is oriented counter to the coating direction, this risk can be minimized. However, advantageously, the cooling-air opening is configured in a conical manner. As a result, the metal layer within the opening does not have an effect on the flow of cooling air. A conical configuration is possible without great effort in particular in the case of introduction by means of laser.

In an alternative or additional configuration of the method, it comprises the additional step of: e) removing the coating over the cooling-air opening by laser and/or by means of electrical discharge machining.

Since deep boring is no longer carried out here, but merely surface removal, such great movability of the tool is not necessary, and so the removal is also possible after assembly and coating of the component. To this end, all that is necessary is to know the precise position of the opening.

A turbine blade is advantageously produced with the described method.

With regard to the turbine blade, the object is achieved in that the turbine blade has a blade airfoil and a blade root, wherein the blade airfoil has a cooling-air opening, the axis of which is directed toward the blade root at the outer side of the blade airfoil.

A turbine advantageously comprises a turbine blade of this kind.

The advantages achieved by the invention arise in particular in that particularly high flexibility with regard to the orientation of the axis of the opening is achieved as a result of the introduction of the cooling-air openings in the separate blade airfoil following casting, and so the cooling-air bores can be oriented in an optimized manner along the flow lines of the hot gas, and the cooling efficiency and thus also the efficiency of the turbine is increased. Even very complex 3D geometries can be cooled effectively by way of the described method.

### BRIEF DESCRIPTION OF THE DRAWINGS

The invention is explained in more detail with reference to a drawing, in which:

FIG. 1 shows a gas turbine in longitudinal partial section,

FIG. 2 shows a stator blade according to the prior art in top view,

FIG. 3 shows a stator blade according to the prior art in section,

FIG. 4 shows a stator blade with cooling holes introduced before assembly of blade airfoil and blade root in top view, and

FIG. 5 shows a stator blade with cooling holes introduced before assembly of blade airfoil and blade root in section.

### DETAILED DESCRIPTION OF INVENTION

Identical parts are provided with the same reference signs in all the figures.

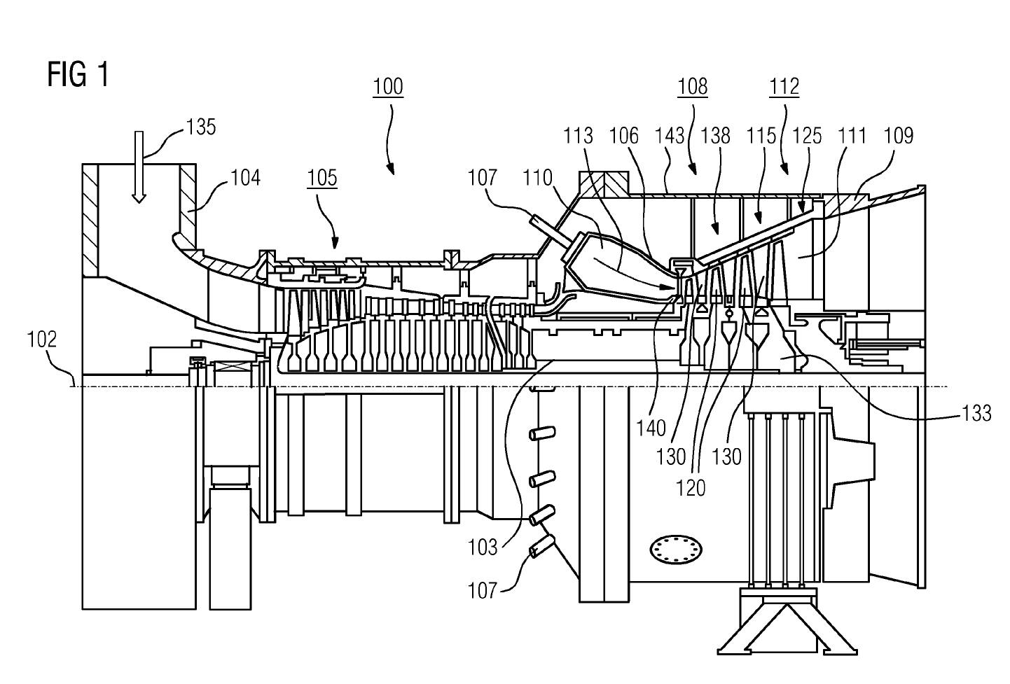

FIG. 1 shows a turbine 100, here a gas turbine, in a longitudinal partial section. The gas turbine 100 has in its interior a rotor 103, also referred to as turbine rotor, that is mounted so as to rotate about a rotation axis 102 (axial direction). An intake housing 104, a compressor 105, a toroidal combustion chamber 110, advantageously an annular combustion chamber 106, having a plurality of coaxially arranged burners 107, a turbine 108 and the exhaust housing 109 follow one another along the rotor 103.

The annular combustion chamber 106 communicates with an annular hot-gas duct 111. There, for example four turbine stages 112 connected in series form the turbine 108. Each turbine stage 112 is formed from two blade rings. As seen in the flow direction of a working medium 113, a row 125 formed from rotor blades 120 follows in the hot-gas duct 111 of a row of stator blades 115.

The stator blades 130 are in this case fastened to the stator 143, whereas the rotor blades 120 of a row 125 are attached to the rotor 103 by means of a turbine disk 133. The rotor blades 120 thus form constituent parts of the rotor 103. Coupled to the rotor 103 is a generator or working machine (not illustrated).

During operation of the gas turbine 100, the compressor 105 sucks in air 135 through the intake housing 104 and compresses it. The compressed air provided at the turbine-side end of the compressor 105 is passed to the burners 107, where it is mixed with a fuel. The mixture is then burnt in the combustion chamber 110, forming the working medium 113. From there, the working medium 113 flows along the hot-gas duct 111 past the stator blades 130 and the rotor blades 120. At the rotor blades 120, the working medium 113 is expanded in a pulse-transmitting manner, such that the rotor blades 120 drive the rotor 103 and the latter drives the working machine coupled to it.

During operation of the gas turbine 100, the components exposed to the hot working medium 113 are subject to thermal stresses. The stator blades 130 and rotor blades 120 of the first turbine stage 112 as seen in the direction of flow of the working medium 113, in addition to the heat shield elements lining the annular combustion chamber 106, are subject to the greatest thermal stresses. In order to withstand the temperatures that prevail there, they are cooled by means of a coolant. Similarly, the blades 120, 130 can have coatings protecting against corrosion (MCrAlX; M=Fe, Co, Ni, rare earths) and heat (thermal insulation layer, for example ZrO₂, Y₂O₄—ZrO₂).

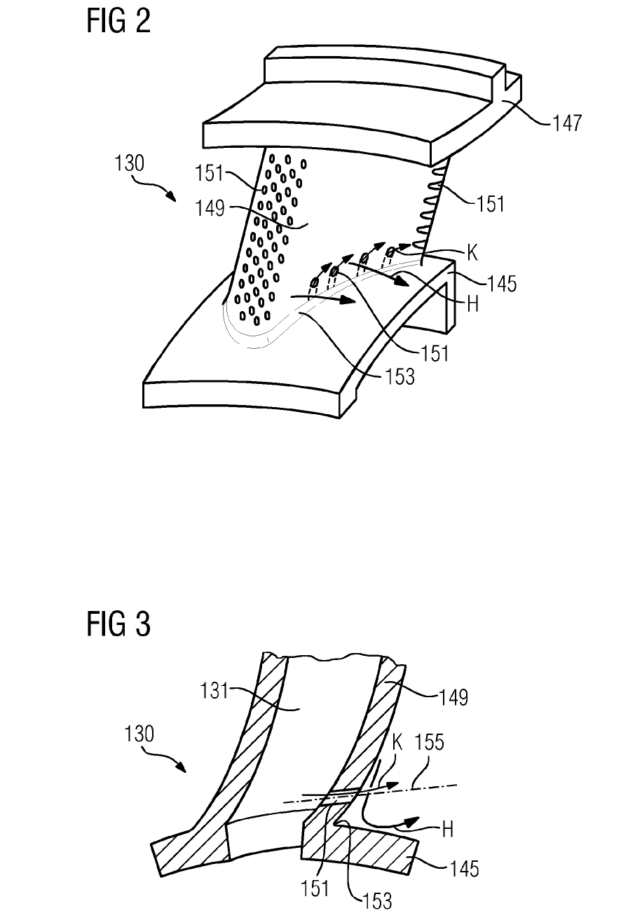

A stator blade 130 according to the prior art is illustrated in top view in FIG. 2 and in partial section in FIG. 3. With regard to FIG. 1, the stator blade 130 has a stator-blade root 145 facing the internal housing 138 of the turbine 108, and a stator-blade head 147 opposite the stator-blade root 145.

The stator-blade head faces the rotor 103 and is fastened to a fastening ring 140 of the stator 143. The stator blade 130 is configured in a hollow manner. A cooling medium, typically air, circulates in the interior space 131.

The stator blade 130 has, in particular at the stator-blade airfoil 149 located between the stator-blade root 145 and stator-blade head 147, a multiplicity of cooling-air openings 151. In the prior art, the cooling-air openings 151 are introduced into the stator blade 130, which is cast in one piece. However, the flexibility of the tool for introducing the cooling-air openings 151 is in this case restricted, in particular in the region of the transition between the stator-blade root 145 and stator-blade airfoil 149, where a concave edge 153 arises. Thus, it was previously only possible to introduce cooling-air openings 151 of which the axis 155 is not directed toward the stator-blade root 145. In FIGS. 2 and 3, arrows show the direction of flow of cooling air K and hot gas H. As FIG. 3 clearly shows, the directions of flow are partially in opposite directions, and so optimum cooling is not ensured and the consumption of cooling air is increased.

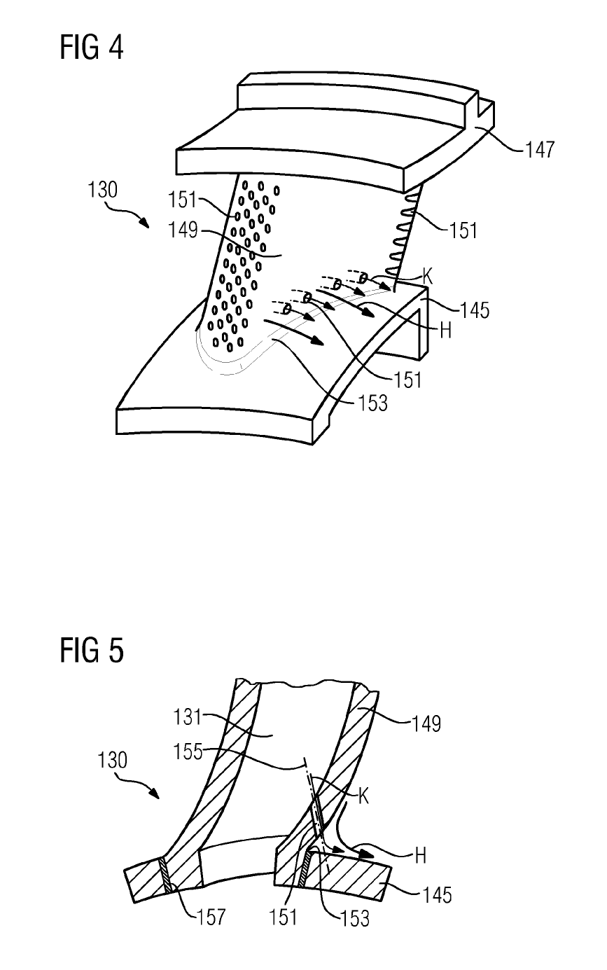

Here, the stator blade 130 shown in FIGS. 4 and 5, which are analogous to FIGS. 2 and 3, respectively, provides a considerable improvement. Here, the axis 155 of the cooling-air opening 151 is directed toward the stator-blade root 145 in the region of the edge 153. As a result, the flow of cooling air K is directed along the flow lines of the hot gas H and substantially improved efficiency of the gas turbine 100 is achieved.

This arrangement of the cooling-air openings 151 is enabled by the production method, which is explained in the following text. First of all, the stator-blade airfoil 149 and stator-blade root 145 are cast separately. Then, the critical cooling-air openings 151 are introduced in the region of the edge 153 by means of laser or electrical discharge machining. The tool is in this case freely movable. Subsequently, the blade root 145 and blade airfoil 149 are connected, for example welded, at the seam 157 shown in FIG. 5.

Subsequently, the stator blade 130 is coated, for example with a metal layer. In this case, the cooling-air openings 151 can become clogged with the coating material. In order that no impairment of the cooling-air flow arises here, the cooling-air openings 151 are configured in a conical manner. Alternatively or in addition, the coating over the cooling-air openings 151 can subsequently be removed again by means of laser or electrical discharge machining. At the same time, further cooling-air openings that are non-critical with regard to accessibility can be introduced.

A stator blade 130 manufactured in such a way increases the efficiency of the gas turbine 100 on account of the improved cooling action.

1.-10. (canceled)

11. A method for producing a turbine blade having a blade airfoil, a blade root and a region with restricted accessibility for a tool for introducing cooling-air openings, said region having a concave edge in the transition between the blade root and blade airfoil, the method comprising:
a) producing a blade airfoil and a blade root as separate components,
b) introducing at least one cooling-air opening into the blade airfoil and/or into the blade root in said region, and
c) assembling the blade airfoil and blade root after step b),
wherein the axis of the cooling-air opening is directed toward or away from the blade root at the outer side of the blade airfoil.

12. The method as claimed in claim 11,
wherein the production of the separate components according to step a) takes place by casting.

13. The method as claimed in claim 11,
wherein the introduction of the at least one air-cooling opening according to step b) takes place by laser and/or by electrical discharge machining.

14. The method as claimed in claim 11, further comprising:
d) coating a region of the blade root and blade airfoil with a coating.

15. The method as claimed in claim 14,
wherein the cooling-air opening is configured in a conical manner.

16. The method as claimed in claim 14, further comprising:
e) removing the coating over the cooling-air opening by laser and/or by electrical discharge machining.

17. A turbine blade produced by the method as claimed in claim 11.

18. A turbine having a turbine blade as claimed in claim 17.
